(19) United States
(12) Patent Application Publication
(10) Pub. No.: US 2008/0236949 A1
(43) Pub. Date: Oct. 2, 2008

(54) MULTI-SECTION LADDER

(76) Inventor: Chen-Hsiung Lin, Chiayi Hsien (TW)

Correspondence Address: NIKOLAI & MERSEREAU, P.A., 900 SECOND AVENUE SOUTH, SUITE 820, MINNEAPOLIS, MN, 55402, US

(21) Appl. No.: 11/691,991

(22) Filed: Mar. 27, 2007

(51) Int. Cl. E06C 1/38; E06C 7/06

(52) U.S. Cl. 182/209; 182/194

(57) ABSTRACT

A multi-section ladder comprises a first ladder and at least one second ladder which respectively includes two upper and lower stiles, two coupling members and a plurality of rung assemblies, the upper stiles provided at the upper ends thereof with two retaining members, the lower stiles provided at the lower ends thereof with two support seats, in specific directions of the support seats in response to the retaining members being individually formed two recesses, the coupling members covered onto the lower ends of the upper stiles and the upper ends of the lower stiles, and the rung assemblies which are equally spaced apart from each other mounted between the inner walls of the two upper or lower stiles, and each of the rung assemblies including two side plates and a rung, thereby disassembling the upper and lower stiles from each other so as to be small in the size of the present invention while in storage.

### BACKGROUND OF THE INVENTION

1. Field of the Invention

The present invention relates to a multi-section ladder, and more particularly to a first ladder and at least one second ladder that can be disassembled into at least two parts, respectively, while in storage, and by means of coupling members, the related components of the present invention allows to be combined together, thereby enabling to be small in its size while in package of storage, so as to be easily and conveniently portable.

2. Description of the Prior Arts

With reference to FIGS. 15 and 16, a conventional combined ladder comprises two individual ladders which respectively include two parallel stiles 9 which are integrally formed by an extrusion process and a plurality of rungs 8. Referring to FIG. 15, although the ladder's length is long enough for the practical demand, its size and length will decrease the movable convenience thereof.

Besides, a plurality of apertures 91 are individually arranged at two sides of the stiles 9 for the insertions of two ends of the rungs 8, on which are arranged ridges 81, with which the outer walls of the stiles 8 are welded, as shown in FIGS. 16 and 17 such that the stiles 9 and the rungs 8 will be matingly positioned, however, the structure strength of the stiles 9 will be reduced due to the arrangement of the apertures 91.

The present invention has arisen to mitigate and/or obviate the afore-described disadvantages.

### SUMMARY OF THE INVENTION

The primary object of the present invention is to provide a multi-section ladder which comprises a first ladder and at least one second ladder that can be disassembled at least two parts, respectively, and by means of coupling members, the related components of the present invention are allowed to be combined together, thereby enabling to be small in its size while in package of storage, so as to be easily and conveniently portable.

The multi-section ladder of the present invention comprises a first ladder and at least one second ladder which respectively includes two upper and lower stiles, two coupling members and a plurality of rung assemblies, the upper stiles provided at the upper ends thereof with two retaining members, the lower stiles provided at the lower ends thereof with two support seats, in specific directions of the support seats in response to the retaining members being individually formed two recesses, the coupling members covered onto the lower ends of the upper stiles and the upper ends of the lower stiles, and the rung assemblies which are equally spaced apart from each other mounted between the inner walls of the two upper or lower stiles, and each of the rung assemblies including two side plates and a rung.

The present invention will become more obvious from the following description when taken in connection with the accompanying drawings, which show, for purpose of illustrations only, the preferred embodiment in accordance with the present invention.

### BRIEF DESCRIPTION OF THE DRAWINGS

FIG. 1 is an assembly view of a first ladder and a second ladder of a multi-section ladder of the present invention;

FIG. 2 is a disassembly view of the first ladder and the second ladder of the present invention;

FIG. 3 is an exploded view of part A of FIG. 1;

FIG. 4 is an exploded view of part B of FIG. 1;

FIG. 5 is an exploded view of part C of FIG. 1;

FIG. 6 is a cross sectional side view of a rung assembly, upper and lower stiles and a coupling member of the present invention;

FIG. 7 is a cross sectional plan view of the rung assembly, the upper and lower stiles and the coupling member of the present invention;

FIG. 8 is an exploded view of the rung assembly of the present invention;

FIG. 9 is a perspective view of ridges at two ends of the rung assembly of the present invention;

FIG. 10 is an assembly view of related components of the rung assembly of the present invention;

FIG. 11 is an exploded view of the rung assemblies, the upper and lower stiles and the coupling member of the present invention;

FIG. 12 is a perspective view of the present invention illustrating a locking member being disposed on each inner wall of the two lower stiles of the second ladder;

FIG. 13 is a cross sectional side view of the present invention illustrating the first ladder, the upwardly moved second ladder and the rungs being securely locking together;

FIG. 14 is a perspective view of a locking member of the multi-section ladder of the present invention;

FIG. 15 is an assembly view of two individual ladders of a conventional combined ladder;

FIG. 16 is an assembly view of rungs and stiles of the conventional ladder;

FIG. 17 is an assembly cross sectional view of a part of rungs and stiles of the conventional ladder.

### DETAILED DESCRIPTION OF THE PREFERRED EMBODIMENT

Referring to FIG. 1, a multi-section ladder in accordance with the present invention comprises a first ladder 1 and at least one second ladder 1a; wherein

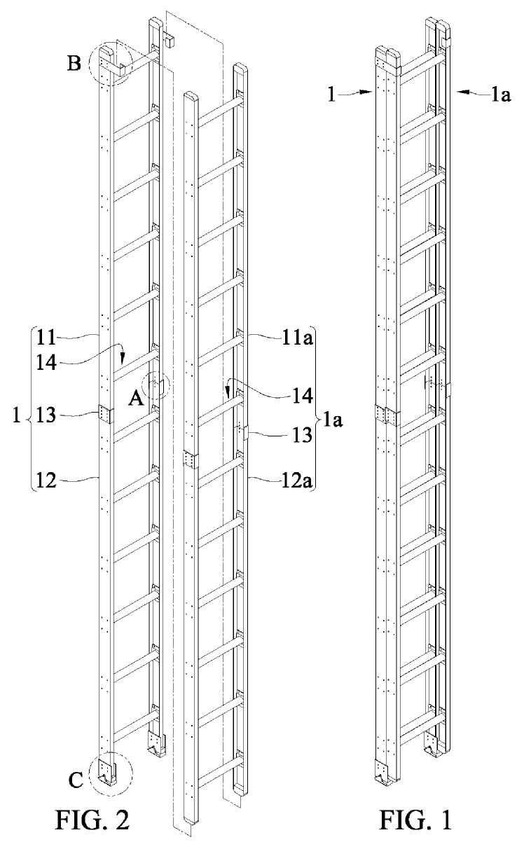

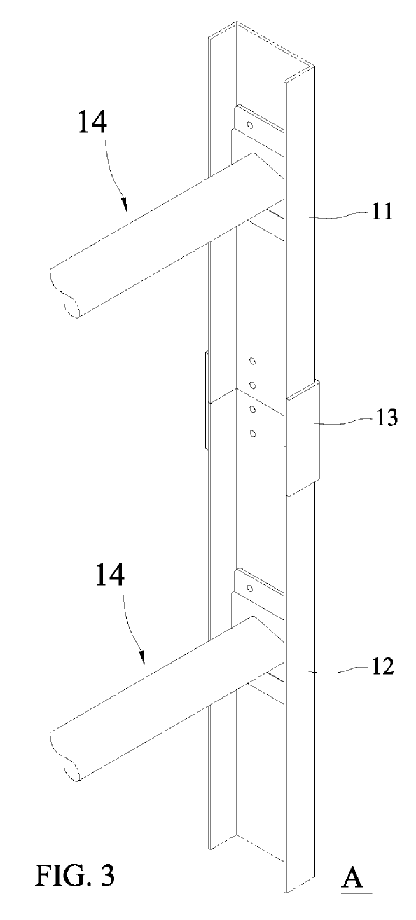

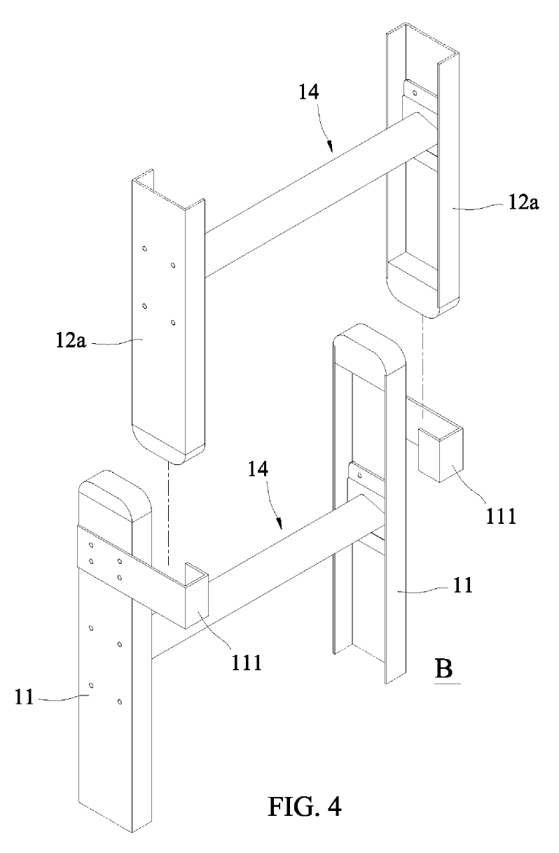

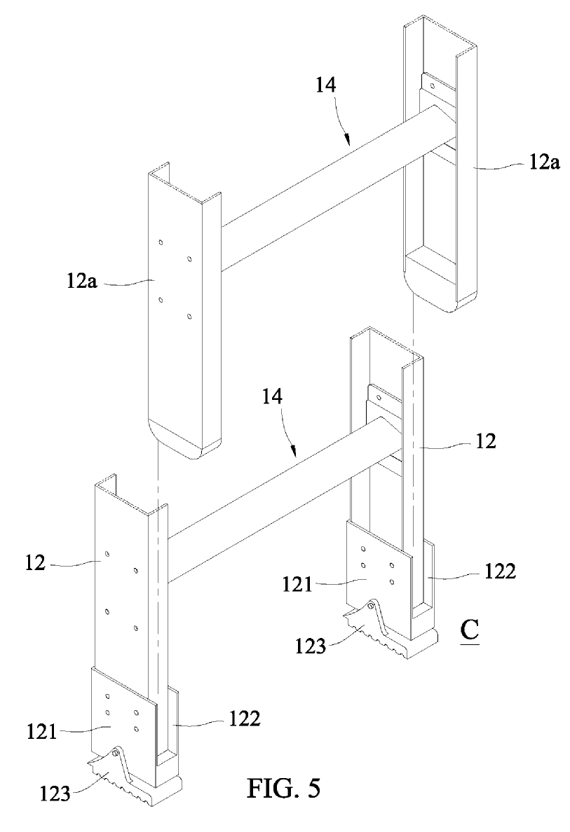

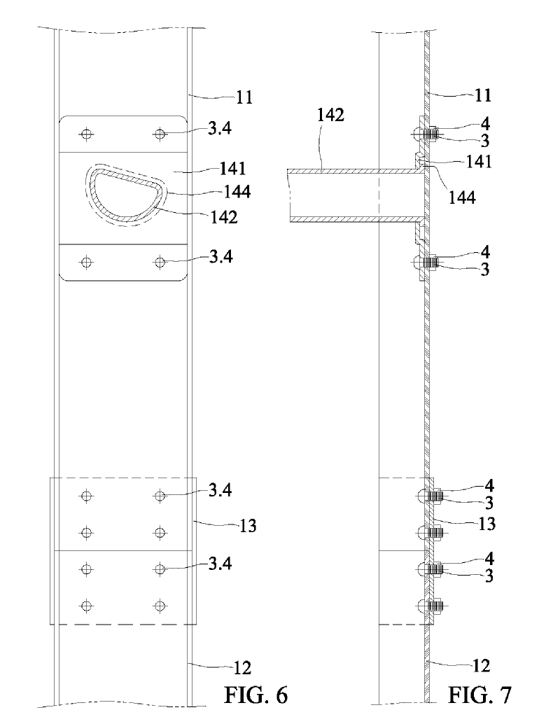

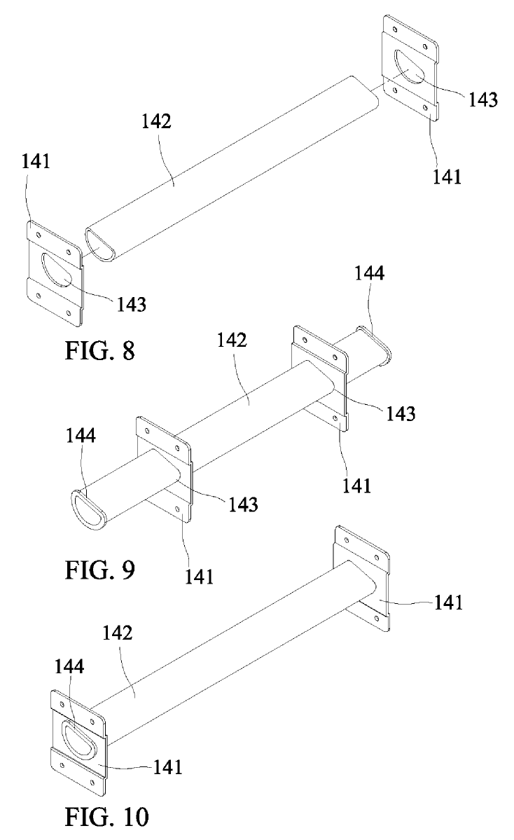

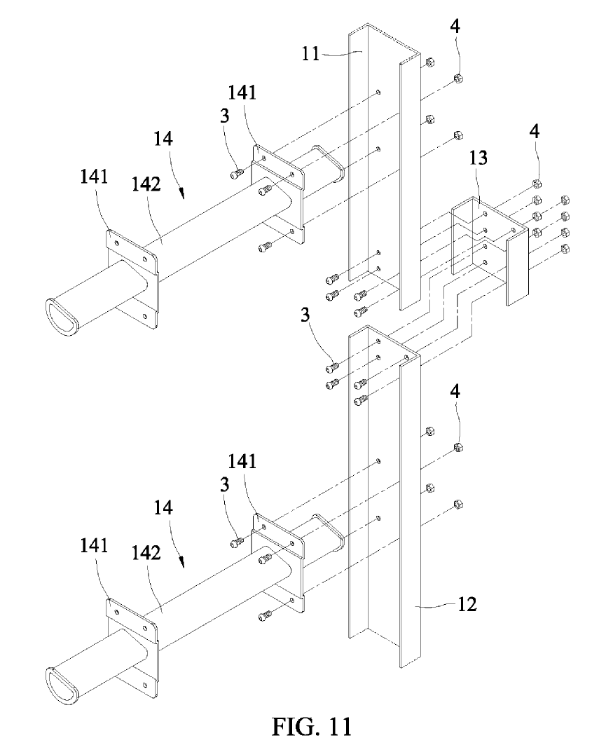

The first ladder 1 includes two upper stiles 11, two lower stiles 12, two coupling members 13 and a plurality of rung assemblies 14. The upper stiles 11, which are provided at the upper ends thereof with two symmetrically projected 7-shaped retaining members 111, are symmetrically parallel to each other, and are in the form of an inverted U-shaped rod, respectively, as shown in FIG. 4. The lower stiles 12 in the form of an inverted U-shaped rod, which are provided at the lower ends thereof with two support seats 121, are symmetrically parallel to each other as shown in FIG. 5, in specific directions of the support seats 121 in response to the retaining members 111 of the upper stiles 11 are individually formed two recesses 122, and at the bottoms of the support seats 121 are pivotally disposed two antiskid mounts 123, respectively. The coupling member 13 in the form of an inverted U-shaped panel, which is covered onto the lower end of the respective upper stiles 11 and the upper end of the lower respective stiles 12 as shown in FIG. 3, and a plurality of screwing elements 3, by which the upper and lower stiles 11, 12 and the coupling members 13 are retained together, are screwed with a number of nuts 4 as illustrated in FIGS. 6 and 7. A plurality of rung assemblies 14, which are equally spaced apart from each other, are mounted between the inner walls of the two upper or lower stiles 11 or 12 as shown in FIG. 2, and each of the rung assemblies 14 is formed of two side plates 141 and a semicircle-shaped rung 142 as illustrated in FIG. 8. In the intermediate portions of the two sides plate members 141 are respectively arranged two semicircle-shaped apertures 143 for the insertions of two ends of the rung 142, and at the ends of the rungs 42 are formed ridges 144 as shown in FIGS. 9-10, such that the two side plates 141 and the rug 142 are combined as a whole, and by way of the screwing elements 3 and the nuts 4, the side plates 141 and the respective upper stiles 11 or the respective lower stiles 12 are matingly screwed together as shown in FIGS. 7 and 11.

Likewise, the second ladder 1a includes two upper stiles 11a, two lower stiles 12a, two coupling members 13 and a plurality of rung assemblies 14 as illustrated in FIGS. 1 and 2. The upper stiles 11a are symmetrically parallel to each other, and are constructed in the form of an inverted U-shaped rod, respectively. The lower stiles 12a in the form of an inverted U-shaped rod are symmetrically parallel to each other, and are coupled to the bottoms of the upper stiles 11a, respectively. The coupling members 13 in the form of an inverted U-shaped panel, which are covered onto the lower ends of the upper stiles 11a and the upper ends of the second stiles 12a, and a plurality of screwing elements 3, by which the upper and lower stiles 11a, 12a and the coupling members 13 are retained together, are screwed with a number of nuts 4. The rung assemblies 14, which are equally spaced apart from each other, are mounted between the inner walls of the two upper or lower stiles 11a or 12a, and each of the rung assemblies 14 is formed of two side plates 141 and a rung 142. In the intermediate portions of the two sides plate members 141 are respectively arranged two semicircle-shaped apertures 143 for the insertions of two ends of the semicircle-shaped rungs 42, and at the ends of the semicircle-shaped rungs 42 are form ridges 144, such that the two side plates 141 and the rug 142 are combined as a whole, and by way of a plurality of screwing elements 3 and nuts 4, the side plates 141 and the upper stiles 11a or the lower stiles 12a are matingly screwed together.

In the assembly of the first ladder 1, the coupling member 13 is covered onto the outer surfaces of the lower end of the respective upper stiles 11 and the upper end of the respective lower stiles 12 as shown in FIG. 3, and by using the screwing elements 3 to screw with the nuts 4 through the respective upper stiles 11 or the respective lower stiles 12 and the individual coupling members 13, the respective upper and lower stiles 11 and 12 are combined as a whole as illustrated in FIGS. 7 and 11. Thereafter, the rung assemblies 14, which are equally spaced apart from each other, are mounted between the inner walls of the two upper or lower stiles 11 or 12 as shown in FIG. 2, and by way of the screwing elements 3 and the nuts 4, either of the side plates 141 and the respective upper stiles 11, or the respective lower stiles 12 are matingly screwed together as shown in FIGS. 7 and 11, thereby assembling the related components of the first ladder 1 together.

In the assembly of the second ladder 1a, the coupling member 13 is covered onto the outer surfaces of the lower end of the respective upper stiles 11a and the upper end of the respective lower stiles 12a, and by using the screwing elements 3 to screw with the nuts 4 through the upper stiles 11a or the lower stiles 12a and the individual coupling members 13, the respective upper and lower stiles 11a and 12a are combined as a whole. Thereafter, the rung assemblies 14, which are equally spaced apart from each other, are mounted between the inner walls of the two upper or lower stiles 11a or 12a, and by way of the screwing elements 3 and the nuts 4, either of the side plates 141 and the respective upper stiles 11a or the respective lower stiles 12a are matingly screwed together, thus assembling the related components of the second ladder 1a together.

With reference to FIG. 1, while abutting the fist ladder 1 and the second ladder 1a together, the lower ends of the lower stiles 12a of the second ladder 1a are inserted through the retaining members 111 at the upper ends of the upper stiles 11 of the first ladder 1 as shown in FIG. 4, and then the lower ends of the lower stiles 12a of the second ladder 1a are correspondingly inserted into the recesses 122 of the support seats 121 at the lower ends of the lower stiles 12 of the first ladder 1 as shown in FIGS. 1 and 5, such that the first ladder 1 and the second ladder 1a can be matingly combined together.

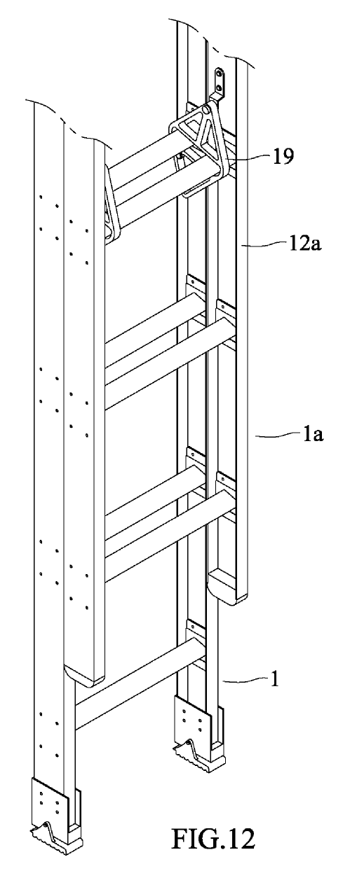

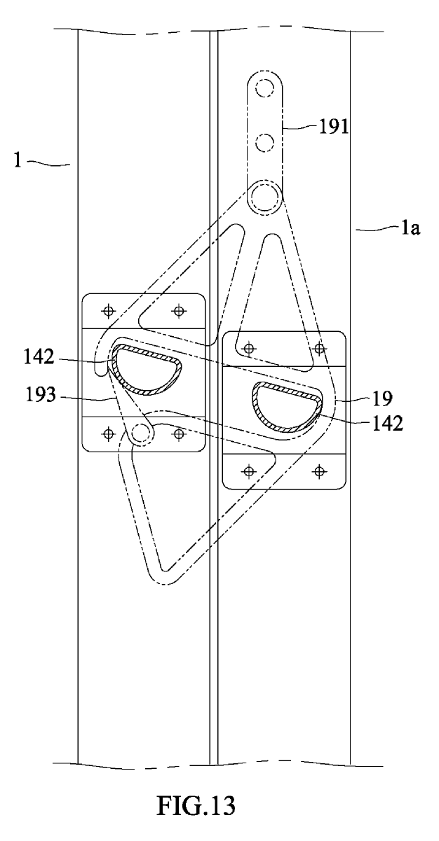

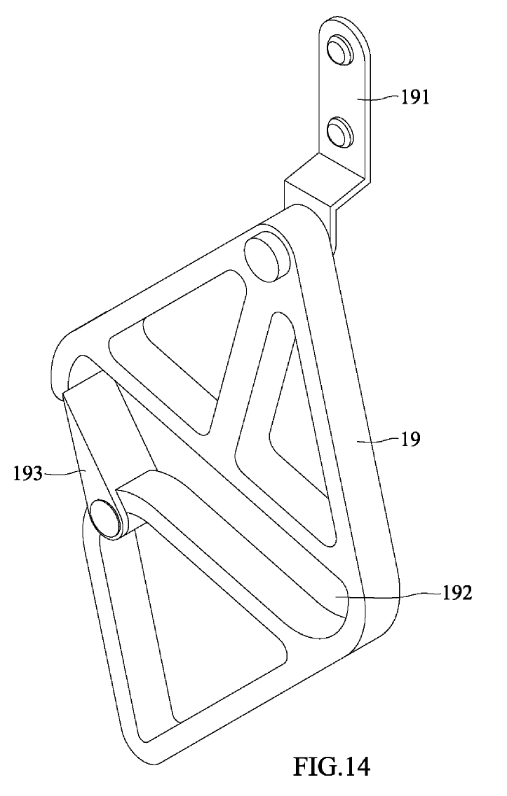

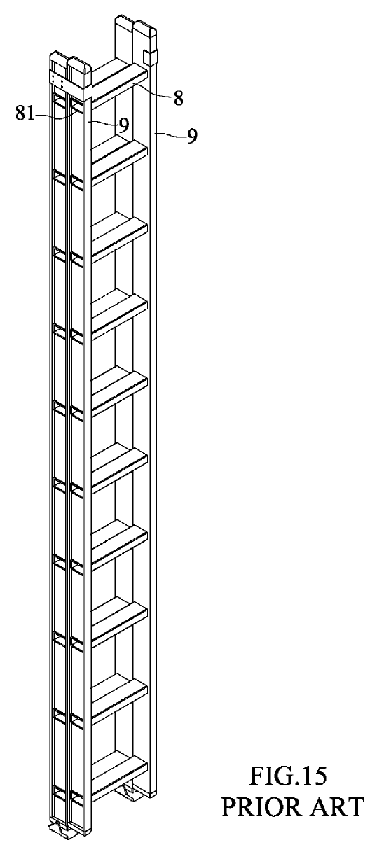

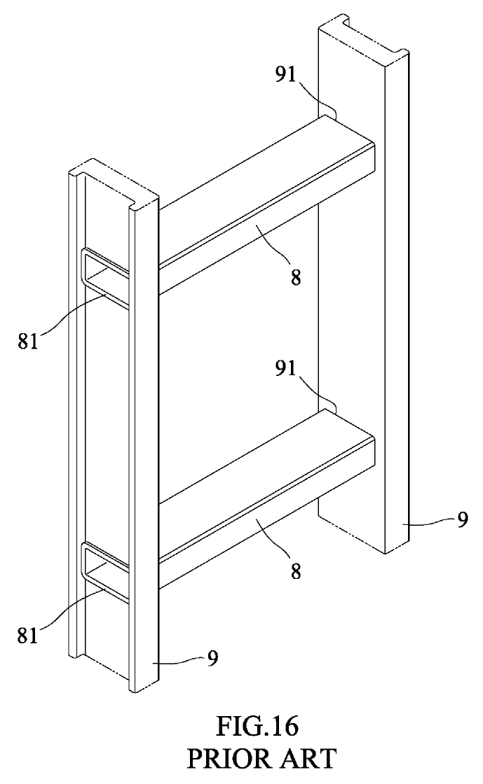

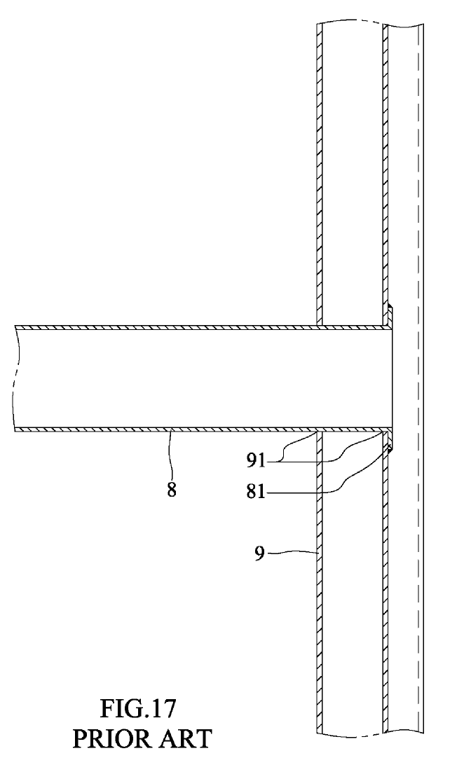

With reference to FIG. 12, on each inner wall of the two lower stiles 12a of the second ladder 1a is disposed a locking member 19, for securely locking the first ladder 1, the upwardly moved second ladder 1a and the rungs 142 together (as illustrated in FIG. 13), the top of the locking member 19 is pivotally connected with the bottom of a connection piece 191 (as shown in FIG. 14), and in the intermediate section of the locking member 19 is formed a rightwardly-facing U-shaped fitting chamber 192 where the open end is rotatably affixed a latching block 193.

It can be clearly seen from the preceding accounts on the features of the present invention that the multi-section ladder of the present invention has the following advantages:

1. The length of the multi-section ladder of the present invention may be shorten, thus enabling to be small in the size of the multi-section ladder while in package of storage so as to be easily and conveniently portable.

2. The multi-section ladder of the present invention includes the semicircle-shaped rung 142 of the rung assembly 14, the flat surface of which faces upwardly and the semicircle-shaped surface faces downwardly for providing a stepping safety.

3. The multi-section ladder includes the rung assemblies 14, each having a rung 142, two ends of which insert through the apertures 143 of the two side plates 141, and the rung 142 has two ridges 144 formed at two ends thereof respectively such that the two side plates 141 and the rung 142 may be firmly assembled as a whole, and by using a plurality of screwing elements 3 to screw with the nuts 4 through the side plates 141, the upper stile 11 or the lower stile 12, the related components of the rung assembly 14 may be fixedly assembled together, and it is unnecessary to arrange a through hole, the shape of which is identical to the semicircle-shaped rung 142, in the upper or the lower stile 11 or 12 so as to maintain the structural strength of the upper or the lower stile 11 or 12.

The invention is not limited to the above embodiment but various modifications thereof may be made. It will be understood by those skilled in the art that various changes in form and detail may made without departing from the scope and spirit of the present invention.

What is claimed is:

1. A multi-section ladder comprising a first ladder provided at the lower end thereof with two antiskid mounts and at least one second ladder; wherein:
said first ladder includes two upper stiles, two lower stiles, two coupling members and a plurality of rung assemblies, said upper stiles are provided at the upper ends thereof with two symmetrically projected retaining members, said lower stiles which are provided at the lower ends thereof with two support seats, in specific directions of said support seats in response to said retaining members of said upper stiles are individually formed two recesses, said coupling members are covered onto the lower ends of said upper stiles and the upper ends of said lower stiles, and a plurality of screwing elements, by which said upper and lower stiles and said coupling members are retained together, are screwed with a number of nuts, said rung assemblies which are equally spaced apart from each other are mounted between the inner walls of said two upper or lower stiles, and each of said rung assemblies is formed of two side plates and a rung;
said second ladder includes two upper stiles, two lower stiles, two coupling members and a plurality of rung assemblies, said lower stiles are coupled to the bottoms of said upper stiles, respectively, said coupling members are covered onto the lower ends of said upper stiles, and a plurality of screwing elements, by which said upper and lower stiles and said coupling members are retained together, are screwed with a number of nuts, said rung assemblies which are equally spaced apart from each other are mounted between the inner walls of said two upper or lower stiles, and each of said rung assemblies is formed of two side plates and a rung;
thereby in the storage of said first and second ladders, disassembling said upper and lower stiles thereof from said coupling members so as to be small in its size, and to be easily and conveniently portable.

2. The multi-section ladder as claimed in claim 1, wherein said two upper and lower stiles of said first and second ladders are symmetrically parallel to each other, and are in the form of an inverted U-shaped rod, respectively.

3. The multi-section ladder as claimed in claim 1, wherein said retaining members at the upper ends of said two upper stiles of said first ladder are constructed in the form of a 7 for matingly mounting said second ladder.

4. The multi-section ladder as claimed in claim 1, wherein said coupling members of said first and second ladders are in the form of an inverted U-shaped panel.

5. The multi-section ladder as claimed in claim 1, wherein in the intermediate portions of said sides plates of said rung assemblies of said first and second ladders are respectively arranged two semicircle-shaped apertures for the insertions of two ends of said semicircle-shaped rungs, and at the ends of said rungs are formed ridges, such that said two side plates and said rug are combined as a whole, and by way of said screwing elements and said nuts, said side plates and said upper stiles or said lower stiles are matingly screwed together.

6. The multi-section ladder as claimed in claim 1, wherein on each inner wall of said two lower stiles of said second ladder is disposed a locking member, for securely locking said first ladder, said upwardly moved second ladder and said rungs together, the top of said locking member is pivotally connected with the bottom of a connection piece, and in the intermediate section of said locking member is formed a rightwardly-facing U-shaped fitting chamber where the open end is rotatably affixed a latching block.
